(19) United States
(12) Patent Application Publication
(10) Pub. No.: US 2024/0418680 A1
(43) Pub. Date: Dec. 19, 2024

(54) INTELLIGENT RECOGNITION METHOD BASED ON FUSION OF DEFECT PULSE SIGNAL AND IMAGE

(71) Applicant: Hefei Institutes of Physical Sciences, Chinese Academy of Sciences, Hefei (CN)

(72) Inventors: Jinggang QIN, Hefei (CN); Xiaochuan LIU, Hefei (CN); Chao ZHOU, Hefei (CN); Huajun LIU, Hefei (CN)

(21) Appl. No.: 18/399,507

(22) Filed: Dec. 28, 2023

(30) Foreign Application Priority Data
Jun. 13, 2023 (CN) 202310695812.1

(51) Int. Cl. G01N 29/06; G01N 29/44

(52) U.S. Cl. CPC G01N 29/069; G01N 29/4445; G01N 29/4463; G01N 29/4472; G01N 2291/0289; G01N 2291/106; G01N 2291/267

(57) ABSTRACT

The present invention provides an intelligent recognition method based on the fusion of a defect pulse signal and an image, comprising: step 1, collecting data, and selecting ultrasonic A scan data and ultrasonic S scan data capable of characterizing defect information on the basis of data obtained by machine scanning a defect, wherein the ultrasonic A scan data is ultrasonic sequence data, and the ultrasonic S scan data is sector image data; step 2, pre-processing the ultrasonic A scan data and the ultrasonic S scan data; step 3, after pre-processing the ultrasonic A scan data and the ultrasonic S scan data, extracting feature information from the ultrasonic A scan data and the ultrasonic S scan as an index for distinguishing defects, and using the feature information respectively extracted from the ultrasonic A scan data and the ultrasonic S scan data as an input variable for classification; step 4, performing feature value evaluation and screening; and step 5, performing a classification task. The present invention is a recognition method for the fusion of two types of defect data features, which may improve the recognition accuracy.

### BACKGROUND

### Technical Field

The present invention belongs to the field of intelligent recognition and non-destructive test filed, particularly relates to an intelligent recognition method based on the fusion of a defect pulse signal and an image.

### Description of the Related Art

At present, welding technology is applied in almost all major industrial sectors, and welding has more stringent technical requirements, particularly in the fields with important technical requirements on aerospace, nuclear power, weapons, and so on. However, the safety problem of the defects existing in the welding position caused by the material defects and the welding technology is always a hot issue. The accurate and rapid recognition and location of material defects is the focus of current non-destructive testing. Previously, the manual qualitative judgment of welding material defects has the shortcomings of slow speed and low accuracy. With the continuous development of computer technology, the pattern recognition combined with non-destructive testing data greatly improves the detection speed and accuracy.

In the nondestructive testing of coarse grained austenitic steel, the location information of defect may be obtained by sector scan, B scan and so on during ultrasonic phased array technology performed. The signal data of defects can be obtained by ultrasonic A scan. However, the current recognition method of the defects combined with the nondestructive detection data in the welds components is almost based on the analysis results obtained from the single signal data or image data.

### BRIEF SUMMARY

In view of the technical problem of defect recognition of weld component with coarse-grained austenitic steel, the present invention provides an intelligent recognition method based on the fusion of a defect pulse signal and an image, and in combination with artificial intelligence, may effectively solve the problems such as slow artificial recognition and low recognition accuracy. This method is based on ultrasonic A scan data and ultrasonic S scan data which can be obtained in ultrasonic phased array technology as the research object to propose an intelligent recognition method. The present invention is a recognition method for the fusion of two types of defect data features, which can improve the recognition accuracy.

In order to achieve the purpose, the invention adopts the following technical solution.

An intelligent recognition method based on the fusion of a defect pulse signal and an image comprises the following steps:

step 1, collecting data,

Ultrasonic A-scan data and S-scan data that can characterize defect information are selected. The A-scan data is ultrasonic sequence data, and the S-scan data is sector image data.

step 2, pre-processing the pulse signal data (A-scan) an image (S-scan image) of the defect;

step 3, extracting feature information from the pre-processed pulse data and image, and taking the feature information as an index for distinguishing the defects, and using the feature information respectively extracted from the pulse signal data and ultrasonic S scan image data as an input variable for classification;

step 4, performing feature evaluation and screening; and

step 5, performing a classification task.

Further, the pre-processing in step 2 comprises noise reduction, and the noise reduction method comprises the following steps:

step 2.1, noise reduction of ultrasonic A scan data: firstly, based on the sym7 wavelet basis function, performing the noise reduction for the ultrasonic A scan data, and then normalizing the data to be (0, 1); and

step 2.2, noise reduction of the ultrasonic S scan data: firstly, median filtering the defect image, then graying the filtered image based on the median filter, and extracting the image features by the feature extraction method after graying the image.

Further, the step 3 comprises:

step 3.1, extracting ultrasonic A scan data features, comprising extracting time-domain features and geometric features of a feature waveform; when extracting the time-domain features, firstly decomposing the A scan pulse into a fourth layer by wavelet packet decomposition, and taking a ratio of the energy of each node of first three nodes of 16 nodes in the fourth layer to total energy of the A scan pulse as one time-domain feature; wherein the calculation formula is

$${E}_{fi} = \frac{E}{{E}_{i}} , i = 1 , 2 , 3 ; {E}_{fi}$$

represents the time-domain feature value calculated by an i^{th} node of the fourth layer after decomposition, E represents the total energy of the A scan pulse, and Eᵢ represents the energy value on the i^{th} node of the fourth layer; if first three nodes are selected in total, three time-domain features are obtained.

Further, in the step 3.1, the geometric features of the feature waveform comprise an envelope length, an area enclosed by the envelope and a horizontal axis, envelope gradient features, two groups of 1-D LBP feature values, a wave root width and a kurtosis; the specific extraction method comprises:

(1) calculating the envelope length and the area enclosed by the envelope and the horizontal axis by calculating the length of the envelope and the area enclosed by the envelope and the horizontal axis by means of differentiation of discrete data, wherein the length of the envelope is calculated by means of differentiation and integration; according to a sampling step length h=1 of the pulse signal and a pulse amplitude corresponding to each sampling point, the calculation formula of the longitudinal axis distance between adjacent sampling points is Δy=f(x+h)−f(x), where Δy is a distance of the longitudinal axis between two adjacent sampling points, and f ( ) represents an amplitude value of the pulse at a certain point, i.e., a value of the longitudinal axis; then, the calculation formula of envelope length is

$$L = {\sum }_{0}^{b} \sqrt{Δ {y}^{2} + {h}^{2}} ,$$

where b represents a sampling length of the feature interval, L represents the length feature, and Σ₀^{b}( ) is a summation formula; the method for calculating the area enclosed by the envelope and the horizontal axis includes, firstly, calculating Δy=f(x+h)−f(x); on this basis, the area enclosed by the envelope and the horizontal axis is calculated by S=Σ₀^{b}(h*Δy)/2, where S represents an area feature value;

(2) calculating of the envelope gradient features, comprising: if an amplitude value of an initial sampling point in the feature interval is set to y₀ and an amplitude value of a next adjacent sampling point is set to y1, setting the difference value between the two to Δy=y₁−y₀; if Δy is less than 0, recording Δy; if Δy is greater than 0, not recording; then moving backward to the next sampling point, calculating Δy between the second and third sampling points, successively calculating sampling points of the feature interval, and summing all the recorded values to obtain an envelope gradient feature value;

(3) the envelope 1-D LBP feature extraction method, comprising:

taking any point in the feature interval as an intermediate point, and respectively selecting three points before and after the intermediate point or four points before and after the intermediate point; when the three points before and after the intermediate point are selected, calculating a difference value between each point of the selected three points before and after the intermediate point and the intermediate point respectively; if the difference value is greater than or equal to 0, assigning the sampling point as 1; if less than 0, assigning the sampling point as 0; then combining six sampling points except the intermediate point into a group of binary numbers and converting the binary numbers into decimal numbers; circularly taking each sampling point as the intermediate point and sequentially calculating the corresponding decimal value of each sampling point, wherein since three points are taken before and after the intermediate point, the decimal points after the conversion are all within (0, 63), this interval is divided into 7 parts equally, and the size of each interval is 9; calculating the number of occurrence times of these decimal points in (0, 7) and (54, 63) as the 1-D LBP feature value; when the four points are taken before and after the intermediate point, dividing (0, 255) into 10 parts equally; calculating the number of occurrence times in the (0, 25.5) and (229.5, 255) as the feature value;

(4) taking the wave root width as a width between the peak starting position and a decline end position of the feature wave, wherein the wave root width is measured by the number of sampling points in the interval;

(5) the calculation formula of kurtosis is as follows:

$$Kurt = \frac{{M}^{4}}{{( {m}^{2} )}^{2}} \qquad ( 1 )$$

$${M}^{4} = \frac{1}{n} \sum {[ A ( k ) - {A}_{a} ]}^{4} \qquad ( 2 )$$

$${m}^{2} = \frac{1}{n} \sum {[ A ( k ) - {A}_{a} ]}^{2} \qquad ( 3 )$$

where A(k) represents amplitude value information of each sampling point; A_{α}

represents a mean value, Kurt represents a kurtosis, and n represents the number of sampling points; M⁴, M², m are transition parameters.

Further, the step 3 comprises:

step 3.2, extracting features of the ultrasonic S scan data, comprising: extracting a gradient and gray level co-occurrence matrix and a gray level co-occurrence matrix, and extracting 18 items of image features, wherein the gradient and gray level co-occurrence matrix extracts 14items of image features, which are small gradient advantages, large gradient advantages, unevenness of gray level distribution, unevenness of gradient distribution, energy, gray level average, gradient average, gray level variance, gradient variance, correlation, gray level entropy, gradient entropy, mixed entropy inertia and inverse difference moment; and the gray level co-occurrence matrix extracts 4 items of features, which are energy, contrast, entropy, and inverse difference moment.

Further, the step 4 comprises:

based on the Euclidean distance method, calculating an intra-class distance and an inter-class distance between the features, and calculating a ratio between the intra-class distance and the inter-class distance as a measuring standard for the separability of feature values, wherein the calculation formulas are as follows:

$$d ( i ( j ) ) = \{ \frac{1}{{N}_{i} * {N}_{i}} {\sum }_{k = 1}^{{N}_{i}} {\sum }_{l = 1}^{{N}_{i}} {d}^{2} ( {X}_{k}^{i} , {X}_{l}^{i} ) \} \qquad ( 4 )$$

$$d ( i , j ) = \{ \frac{1}{{N}_{i} * {N}_{j}} {\sum }_{k = 1}^{{N}_{i}} {\sum }_{l = 1}^{{N}_{j}} {d}^{2} ( {X}_{K}^{i} , {X}_{l}^{j} ) \} \qquad ( 5 )$$

$${d}^{2} = \sqrt{{X}_{K}^{{i}^{2}} + {X}_{K ( l )}^{{i ( j )}^{2}}} \qquad ( 6 )$$

$${K}_{i , j} = \frac{d ( i , j )}{d ( i ) + d ( j )} \qquad ( 7 )$$

Formula (4) is a calculation formula for calculating the intra-class distance, Formula (5) is a calculation formula for calculating the distance between classes, Formula (6) is an Euclidean distance calculation method, and Formula (7) is an index for evaluating the separability norm; the above-mentioned formulas are standard calculation formulas, where Nᵢ is the number of a certain defect sample, Nj is a parameter of another type of defect sample, k represents a k^{th} sample, l represents a l^{th} sample, and d² ( ) represents a Euclidean distance calculation formula; X_{K}ⁱ, Xₗⁱ respectively represents a feature value of the k^{th} sample of the i^{th} class and represents a feature value of a l^{th} sample of the i^{th} class; i and j respectively represent two types of defects; X_{K}ⁱ, Xₗⁱ respectively represents the k^{th} sample and the l^{th} sample of the j-type defects, and K_{i,j} is a finally calculated separability criterion value;

according to the calculation result of Formula (7) as the measuring standard, if the result is greater than 1, it is considered to have the separability; and if the result is less than 1, this feature is not used as the input feature for subsequent classification.

Further, a BP neural network model based on a full connection layer is constructed in the classification task in step 5; the separability features are screened according to the measuring standard of the separability of each feature calculated in steps 1-4 as an input; the image and the signal features are input in parallel at the input layer; and results are finally output by calculating a weight between the features of ultrasonic A scan data and the features of ultrasonic S scan data at each node.

### BENEFICIAL EFFECTS

The innovation of the present invention lies in the feature fusion part. On the basis of previous single-type data research, the present invention fuses the features of two types of data by feature fusion, effectively embodying the complementary advantages of feature fusion, effectively improving the accuracy of defect classification and improving the robustness of model classification.

### BRIEF DESCRIPTION OF THE SEVERAL VIEWS OF THE DRAWINGS

FIG. 1 is a flowchart of an intelligent recognition method based on the fusion of a defect pulse signal and an image according to the present invention;

FIG. 2 is a model structure diagram of an intelligent recognition method based on the fusion of a defect pulse signal and an image according to the present invention.

### DETAILED DESCRIPTION

In order that the objects, aspects, and advantages of the invention will become more apparent, a more particular description of the invention will be rendered by reference to the appended drawings and embodiments. It should be understood that the specific examples described herein are merely used for explanation of the invention and are not intended to be limiting thereof. Furthermore, the technical features involved in the various embodiments of the present invention described below may be combined with each other as long as they do not conflict with each other.

The present invention is exemplified by five types of defects, i.e., cracks, pores, slag inclusion, incomplete penetration, and non-fusion.

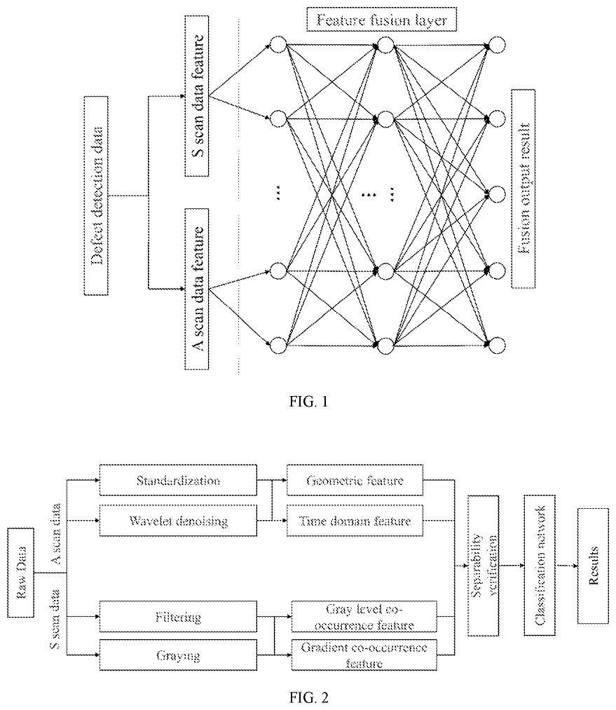

As shown in FIGS. 1 and 2, an intelligent recognition method based on the fusion of a defect pulse signal and image of the present invention includes the following steps.

Step 1, Data Collecting

The ultrasonic A scan data and ultrasonic S scan data capable of characterizing defect information are selected based on the data obtained by machine scanning a defect. The ultrasonic A scan data is ultrasonic sequence data, and the ultrasonic S scan data is sector image data.

Step 2, Data Pre-Processing

Because of the influence of human factors and steel itself, there is a certain amount of noise in the collected data, which will affect the feature information of the data. Therefore, it is necessary to pre-process the data before feature extraction to eliminate the influence of noise contained in the data. The noise reduction method includes the following steps.

Step 2.1. Noise reduction of ultrasonic A scan data: since the ultrasonic A scan data is ultrasonic sequence data with noise in the waveform, the ultrasonic A scan data is firstly denoised based on the sym7 wavelet basis function (based on the sym7 wavelet basis function in the symlet (wavelet filter) wavelet system), and the denoising effect is the best. The calculation formula thereof is

$${ω}_{j , k}^{′} = \{ \begin{matrix}sgn ( {ω}_{j , k} ) ( \vert {ω}_{j , k} - β \vert ) , & \vert {ω}_{j , k} \vert \geq β \\ 0 , & \vert {ω}_{j , k} \vert < β\end{matrix} ,$$

where sgn(*) is a signed function; B is a threshold and σ\sqrt{2lnN}; σ is taken as a noise standard deviation; ω_{j,k} represents elements of row j and column k in a signal matrix; and ω′_{j,k} represents the elements after noise reduction. On the basis of noise reduction, since there is a difference in the amplitude value of each feature waveform due to the scanning problem, it is necessary to normalize the deleted data after noise reduction so that it is within the (0, 1). Its normalized calculation formula is

$${X}_{j} = \frac{{X}_{i} - {X}_{min}}{{X}_{max} - {X}_{min}} ,$$

where Xⱼ is the normalized sampling point value. Xᵢ is an original sampling point. Xₘₐₓ is a maximum of the signal amplitude values. Xₘᵢₙ is a minimum of the signal amplitude values.

Step 2.2, Noise reduction of ultrasonic S scan data: because the ultrasonic S scan data is sector image data, the image data processing method is used to reduce noise. Firstly, the defect image median filter is used. Based on median filter, the traditional feature extraction method and depth convolution method are considered in feature extraction, but the depth convolution method needs a large number of data sets for classification. Therefore, the filtered image is grayed and then the feature values are extracted by the traditional feature extraction method.

Step 3, performing feature extraction

After sufficient preprocessing of the data, it is necessary to extract the feature information of the data as an index for identifying defects. The feature information respectively extracted from the ultrasonic A scan data and ultrasonic S scan data is used as an input variable for classification. It specifically includes:

Step 3.1, extracting features of ultrasonic A scan data, including that slight differences between defects may be observed visually from the waveforms, but the similarity between partial defects is still large. For example, the feature waveforms between slag inclusion and non-fusion defects are very similar. After analysis, the geometric features of the feature waveform are extracted as part of the feature variable. In addition, in the time domain, the relationship between the energy of each node and the total energy is calculated by wavelet packet decomposition waveform. It is found that there is also a difference between energy values between part of waveforms. Thus, the feature information of this part in the time domain is also taken as part of the feature variables.

There are seven geometric features of the waveform, including: an envelope length, an area enclosed by the envelope and a horizontal axis, envelope gradient features, two groups of 1-D LBP (Local Binary Pattern) feature values, a wave root width and a kurtosis. The specific feature extraction method includes the followings.

(1) The envelope length and the area enclosed by the envelope and the horizontal axis are calculated as follows. The envelope length and the area enclosed by the envelope and the horizontal axis are calculated by the method of differentiation of discrete data. The length of the envelope is calculated with the idea of differentiation and integration. According to the sampling step of pulse signals, h=1 and each sampling point corresponding to the pulse amplitude, the calculation formula for the longitudinal axis distance between adjacent sampling points is Δy=f(x+h)−f(x), where Δy is a distance of the longitudinal axis between two adjacent sampling points, h is a sampling step length and is fixed as 1; F ( ) represents an amplitude value of the pulse at a certain point (i.e., the value of the longitudinal axis). Then, the calculation formula of envelope length is

$$L = {\sum }_{0}^{b} \sqrt{Δ {y}^{2} + {h}^{2}} ,$$

where b represents a sampling length of the feature interval, L represents a length feature, and Σ₀^{b}( ) is a summation formula.

The area enclosed by the calculated envelope and the horizontal axis is the same as that in the idea used for calculating the length. Firstly on this basis, the area enclosed by the horizontal axis and the envelope is calculated by S=Σ₀^{b}(h*Δy)/2, where S represents an area feature value.

(2) The envelope gradient feature is one of the geometric features, and the calculation method thereof includes setting the amplitude of the initial sampling point of the feature interval as y₀, and the amplitude value of the next adjacent sampling point as y₁, then the difference value Δy between the two being Δy=y₁−y₀; if Δy is less than 0, recording the Δy; and if Δy is greater than 0, not recording; then moving backward to the next sampling point, calculating Δy between the second and third sampling points, successively calculating sampling points of the feature interval, and summing all the recorded values to obtain an envelope gradient feature value.

(3) As shown in FIG. 3, the 1-D LBP feature value extraction method is a feature extraction method mapped on one-dimensional data based on a method of processed image data feature extraction. The 1-D LBP feature value extraction method includes taking any point in the feature interval as the intermediate point, and respectively selecting three points before and after the intermediate point or four points before and after the intermediate point. Three points before and after the intermediate point are chosen as examples. The difference values between each point of the selected three points before and after the intermediate point and the intermediate point are respectively calculated. If the difference value is greater than or equal to 0, the sampling point is assigned as 1. If the difference value is less than 0, the sampling point is assigned as 0. Then six sampling points are combined into a group of binary numbers and the binary numbers are converted into decimal numbers. In a loop, for each sampling point taken as an intermediate point, the decimal value corresponding to the sampling point as the intermediate point is calculated in turn. The number of sampling points will correspond to the number of decimal values. Since three points are taken before and after the intermediate point, the decimal points after the conversion are all within the range of (0, 63), this interval is divided into 7 parts, and the size of each interval is 9. The number of times these decimal points occur in (0, 7) and (54, 63) is calculated as the 1-D LBP feature value. Four points before and after the intermediate point are taken in the same method as above, but then the interval (0, 255) is divided into 10 parts, and the times of occurrence in the intervals (0, 25.5) and (229.5, 255) are calculated as feature values.

(4) taking the wave root width as a width between the peak starting position and a decline end position of the feature wave, wherein the wave root width is measured by the number of sampling points in the interval;

(5) Kurtosis is an index that describes the sharpness of a waveform and is calculated as follows:

$$Kurt = \frac{{M}^{4}}{{( {m}^{2} )}^{2}} \qquad ( 1 )$$

$${M}^{4} = \frac{1}{n} \sum {[ A ( k ) - {A}_{a} ]}^{4} \qquad ( 2 )$$

$$m = \frac{1}{n} \sum {[ A ( k ) - {A}_{a} ]}^{2} \qquad ( 3 )$$

where A(k) represents amplitude information of each sampling point; A_{α} represents a mean value, Kurt represents a kurtosis, and n represents the number of sampling points. M⁴, M², m are transition parameters. The feature information extraction in time domain is based on the energy-to-total energy ratio of first three nodes on 16 nodes of a fourth layer after the four-layer wavelet packet decomposition as a feature value. Therefore, three pieces of feature information are extracted in the time domain, respectively being the ratios of the first three nodes on the fourth layer to the total energy.

Step 3.2, extracting the features of ultrasonic S scan data: since the ultrasonic S scan data is sector image data, the feature information of the image is extracted by the traditional image feature extraction method. It is realized by two methods: 1, gradient and gray level co-occurrence matrix; 2, gray level co-occurrence matrix. A total of 18 image features are extracted. Among them, 14 image features are extracted by a gradient and gray level co-occurrence co-matrix, which are small gradient advantages, large gradient advantages, unevenness of gray level distribution, unevenness of gradient distribution, energy, gray level average, gradient average, gray level variance, gradient variance, correlation, gray level entropy, gradient entropy, mixed entropy inertia and inverse difference moment. The gray level co-occurrence matrix extracts four features, which are energy, contrast, entropy, and inverse difference moment.

Step 4, performing feature evaluation and screening.

Some of the feature values extracted above have no obvious separability. Thus, it is necessary to evaluate the separability of the feature values and select the feature values with separability as the input of network classification, which may improve the classification accuracy. The evaluation norm for feature values based on the Euclidean distance method includes calculating a intra-class distance and an inter-class distance between the features, and calculating a ratio between the intra-class distance and the inter-class distance as a measuring standard for the separability of feature values. The calculation formulas are as follows:

$$d ( a ( b ) ) = \{ \frac{1}{{N}_{i} * {N}_{i}} {\sum }_{k = 1}^{{N}_{i}} {\sum }_{l = 1}^{{N}_{i}} {d}^{2} ( {X}_{K}^{i} , {X}_{l}^{i} ) \} \qquad ( 4 )$$

$$d ( a , b ) = \{ \frac{1}{{N}_{i} * {N}_{j}} {\sum }_{k = 1}^{{N}_{i}} {\sum }_{l = 1}^{{N}_{j}} {d}^{2} ( {X}_{K}^{i} , {X}_{l}^{j} ) \} \qquad ( 5 )$$

$${d}^{2} = \sqrt{{X}_{K}^{{i}^{2}} + {X}_{K ( l )}^{{i ( j )}^{2}}} \qquad ( 6 )$$

$${K}_{a , b} = \frac{d ( a , b )}{d ( a ) + d ( b )} \qquad ( 7 )$$

Formula (4) is a calculation formula for calculating the intra-class distance, and Formula (5) is a calculation formula for calculating the inter-class distance. Formula (6) is the Euclidean distance calculation method, and an index for evaluating the distinguishability norm is calculated by Formula (7). Nᵢ is the number of samples having some defect. K represents a k^{th} sample. L represents a l^{th} sample and d² ( ) represents the Euclidean distance calculation formula. X_{K}ⁱ, Xₗⁱ represent the feature value of the k^{th} sample of the i^{th} class and the feature value of the l^{th} sample of the i^{th} class respectively; i, j respectively represent two types of defects.

According to the calculation result of Formula (7) as the measuring standard, if the result is greater than 1, it is considered to have the separability; and if the result is less than 1, this feature is not used as the input feature for subsequent classification.

Step 5, performing a classification task.

A BP neural network model based on a full connection layer is constructed in the classification task. The separability features are screened according to the measuring standard of the separability of each feature calculated as an input. The image and the signal features are input in parallel at the input layer. Results are finally output by calculating a weight between the features of ultrasonic A scan data and the features of ultrasonic S scan data at each node of a hidden layer, namely, the hidden layer is a feature fusion layer. A schematic diagram of the constructed BP neural network is shown in FIG. 1.

With regard to the setting of neural network parameters, the number of hidden layers and the number of nodes of hidden layers may be adjusted according to the number of inputs and the number of outputs, so that the classification effect reaches an optimal result.

It will be readily understood by those skilled in the art that the above mentioned are only preferred embodiments of the invention and is not intended to limit the invention. Any modification, equivalent substitution and improvement made within the spirit and principles of the invention shall be covered by the protection of the invention.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An intelligent recognition method based on the fusion of a defect pulse signal and an image, characterized by comprising the following steps:
step 1, collecting data, and selecting ultrasonic A scan data and ultrasonic S scan data capable of characterizing defect information on the basis of data obtained by machine scanning a defect, wherein the ultrasonic A scan data is ultrasound ultrasonic sequence data, and the ultrasonic S scan data is sector image data;
step 2, pre-processing the ultrasonic A scan data and the ultrasonic S scan data;
step 3, extracting feature information from the pre-processed ultrasonic A scan data and ultrasonic S scan data, and taking the feature information as an index for distinguishing the defects, and using the feature information respectively extracted from the ultrasonic A scan data and ultrasonic S scan data as an input variable for classification, comprising:
step 3.1, extracting ultrasonic A scan data features, comprising extracting time-domain features and geometric features of a feature waveform; when extracting the time-domain features, firstly decomposing the A scan pulse into a fourth layer by wavelet packet decomposition, and taking a ratio of the energy of each node of first three nodes of 16 nodes in the fourth layer to total energy of the A scan pulse as one time-domain feature; wherein the calculation formula
$${E}_{fi} = \frac{E}{{E}_{i}} , i = 1 , 2 , 3 ; {E}_{fi}$$
represents the time-domain feature value calculated by an i^{th} node of the fourth layer after decomposition, E represents the total energy of the A scan pulse, and Eᵢ represents the energy value on the i^{th} node of the fourth layer; if first three nodes are selected in total, three time-domain features are obtained;
in the step 3.1, the geometric features of the feature waveform comprise an envelope length, an area enclosed by the envelope and a horizontal axis, envelope gradient features, two groups of 1-D LBP feature values, a wave root width and a kurtosis; the specific extraction method comprises:
(1) calculating the envelope length and the area enclosed by the envelope and the horizontal axis by calculating the length of the envelope and the area enclosed by the envelope and the horizontal axis by means of differentiation of discrete data, wherein the length of the envelope is calculated by means of differentiation and integration; according to a sampling step length h=1 of the pulse signal and a pulse amplitude corresponding to each sampling point, the calculation formula of the longitudinal axis distance between adjacent sampling points is Δy=f(x+h)−f(x), where x represents a value of the horizontal axis, Δy is a distance of the longitudinal axis between two adjacent sampling points, and f ( ) represents an amplitude value of the pulse at a certain point, i.e., a value of the longitudinal axis; then, the calculation formula of envelope length is
$$L = {\sum }_{0}^{b} \sqrt{Δ {y}^{2} + {h}^{2}} ,$$
where b represents a sampling length of the feature interval, L represents the length feature, and Σ₀^{b}( ) is a summation formula; the method for calculating the area enclosed by the envelope and the horizontal axis includes, firstly, calculating Δy=f(x+h)−f(x); on this basis, the area enclosed by the envelope and the horizontal axis is calculated by S=Σ₀^{b}(h*Δy)/2, where S represents an area feature value;
(2) calculating of the envelope gradient features, comprising: if an amplitude value of an initial sampling point in the feature interval is set to y₀ and an amplitude value of a next adjacent sampling point is set to y₁, setting the difference value between the two to Δy=y₁-y₀; if Δy is less than 0, recording Δy; if Δy is greater than 0, not recording; then moving backward to the next sampling point, calculating Δy between the second and third sampling points, successively calculating sampling points of the feature interval, and summing all the recorded values to obtain an envelope gradient feature value;
(3) the envelope 1-D LBP feature extraction method, comprising:
taking any point in the feature interval as an intermediate point, and respectively selecting three points before and after the intermediate point or four points before and after the intermediate point; when the three points before and after the intermediate point are selected, calculating a difference value between each point of the selected three points before and after the intermediate point and the intermediate point respectively; if the difference value is greater than or equal to 0, assigning the sampling point as 1; if less than 0, assigning the sampling point as 0; then combining six sampling points except the intermediate point into a group of binary numbers and converting the binary numbers into decimal numbers; circularly taking each sampling point as the intermediate point and sequentially calculating the corresponding decimal value of each sampling point, wherein since three points are taken before and after the intermediate point, the decimal points after the conversion are all within (0, 63), this interval is divided into 7 parts equally, and the size of each interval is 9; calculating the number of occurrence times of these decimal points in (0, 7) and (54, 63) as the 1-D LBP feature value; when the four points are taken before and after the intermediate point, dividing (0, 255) into 10 parts equally; calculating the number of occurrence times in the (0, 25.5) and (229.5, 255) as the feature value;
(4) taking the wave root width as a width between the peak starting position and a decline end position of the feature wave, wherein the wave root width is measured by the number of sampling points in the interval;
(5) the calculation formula of kurtosis is as follows:
$$Kurt = \frac{{M}^{4}}{{( {m}^{2} )}^{2}} \qquad ( 1 )$$
$${M}^{4} = \frac{1}{n} \sum {[ A ( k ) - {A}_{a} ]}^{4} \qquad ( 2 )$$
$${m}^{2} = \frac{1}{n} \sum {[ A ( k ) - {A}_{a} ]}^{2} \qquad ( 3 )$$
where A(k) represents amplitude value information of each sampling point; A_{α} represents a mean value, Kurt represents a kurtosis, and n represents the number of sampling points; M⁴, m² are transition parameters;
step 4, performing feature evaluation and screening; and
step 5, performing a classification task.

2. The intelligent recognition method based on the fusion of a defect pulse signal and an image according to claim 1, characterized in that the pre-processing in step 2 comprises noise reduction, and the noise reduction method comprises the following steps:
step 2.1, noise reduction of ultrasonic A scan data: firstly, based on the sym7 wavelet basis function, performing the noise reduction for the ultrasonic A scan data, and then normalizing the data to be (0, 1); and
step 2.2, noise reduction of the ultrasonic S scan data: firstly, median filtering the defect image, then graying the filtered image based on the median filter, and extracting the image features by the feature extraction method after graying the image.

3. The intelligent recognition method based on the fusion of a defect pulse signal and an image according to claim 1, characterized in that the step 3 comprises:
step 3.2, extracting features of the ultrasonic S scan data, comprising: extracting a gradient and gray level co-occurrence matrix and a gray level co-occurrence matrix, and extracting 18 items of image features, wherein the gradient and gray level co-occurrence matrix extracts 14 items of image features, which are small gradient advantages, large gradient advantages, unevenness of gray level distribution, unevenness of gradient distribution, energy, gray level average, gradient average, gray level variance, gradient variance, correlation, gray level entropy, gradient entropy, mixed entropy inertia and inverse difference moment; and the gray level co-occurrence matrix extracts 4 items of features, which are energy, contrast, entropy, and inverse difference moment.

4. The intelligent recognition method based on the fusion of a defect pulse signal and an image according to claim 3, characterized in that the step 4 comprises:
based on the Euclidean distance method, calculating an intra-class distance and an inter-class distance between the features, and calculating a ratio between the intra-class distance and the inter-class distance as a measuring standard for the separability of feature values, wherein the calculation formulas are as follows:
$$d ( i ( j ) ) = \{ \frac{1}{{N}_{i} * {N}_{i}} {\sum }_{k = 1}^{{N}_{i}} {\sum }_{l = 1}^{{N}_{i}} {d}^{2} ( {X}_{k}^{i} , {X}_{l}^{i} ) \} \qquad ( 4 )$$
$$d ( i , j ) = \{ \frac{1}{{N}_{i} * {N}_{j}} {\sum }_{k = 1}^{{N}_{i}} {\sum }_{l = 1}^{{N}_{j}} {d}^{2} ( {X}_{K}^{i} , {X}_{l}^{j} ) \} \qquad ( 5 )$$
$${d}^{2} = \sqrt{{X}_{K}^{{i}^{2}} + {X}_{K ( l )}^{{i ( j )}^{2}}} \qquad ( 6 )$$
$${K}_{i , j} = \frac{d ( i , j )}{d ( i ) + d ( j )} \qquad ( 7 )$$
Formula (4) is a calculation formula for calculating the intra-class distance, Formula (5) is a calculation formula for calculating the distance between classes, Formula (6) is an Euclidean distance calculation method, and Formula (7) is an index for evaluating the separability norm; the above-mentioned formulas are standard calculation formulas, where Ni is the number of a certain defect sample, Nj is a parameter of another type of defect sample, k represents a k^{th} sample, l represents a l^{th} sample, and d² ( ) represents a Euclidean distance calculation formula; X_{K}ⁱ, Xₗⁱ respectively represents a feature value of the k^{th} sample of the i^{th} class and represents a feature value of a l^{th} sample of the i^{th} class; i and j respectively represent two types of defects; X_{K}ⁱ, Xₗⁱ respectively represents the k^{th} sample and the l^{th} sample of the j-type defects, and K_{i,j} is a finally calculated separability criterion value;
according to the calculation result of Formula (7) as the measuring standard, if the result is greater than 1, it is considered to have the separability; and if the result is less than 1, this feature is not used as the input feature for subsequent classification.

51 The intelligent recognition method based on the fusion of a defect pulse signal and an image according to claim 4, characterized in that a BP neural network model based on a full connection layer is constructed in the classification task in step 5; the separability features are screened according to the measuring standard of the separability of each feature calculated in steps 1-4 as an input; the image and the signal features are input in parallel at the input layer; and results are finally output by calculating a weight between the features of ultrasonic A scan data and the features of ultrasonic S scan data at each node.
